(19) United States
(12) Patent Application Publication
(10) Pub. No.: US 2014/0129480 A1
(43) Pub. Date: May 8, 2014

(54) INVESTMENT RISK MANAGEMENT SYSTEM AND METHOD

(71) Applicants: Jeffrey William LeRose, Cary, NC (US); Charles Kenneth ReCorr, Cary, NC (US); Shana Lynn King, CARY, NC (US)

(72) Inventors: Jeffrey William LeRose, Cary, NC (US); Charles Kenneth ReCorr, Cary, NC (US); Shana Lynn King, CARY, NC (US)

(21) Appl. No.: 14/062,514

(22) Filed: Oct. 24, 2013

Related U.S. Application Data
(60) Provisional application No. 61/722,292, filed on Nov. 5, 2012.

(51) Int. Cl. G06Q 40/06

(52) U.S. Cl. CPC G06Q 40/06
USPC 705/36 R

(57) ABSTRACT

A system and method of assessing a future investment. The present invention may include entering in personal information and investment information. The user may be present invention with a series of risk and reward questions or statements in which the user may agree with or disagree with. The questions may change based on the entered information. The questions may progressively increase the risk and/or reward users are willing to take to achieve their goals. Once the questions have been answered, the software prepares and provides a risk and reward assessment.

### CROSS-REFERENCE TO RELATED APPLICATION

This application claims the benefit of priority of U.S. provisional application No. 61/722,292 filed Nov. 5, 2012, the contents of which are herein incorporated by reference.

### BACKGROUND OF THE INVENTION

The present invention relates to a risk management system and, more particularly, to an investment risk management system.

Currently, it is difficult to determine objectively how much a user is willing to spend and risk. The market is very volatile and therefore knowing the user's tolerance of risk and reward allows a user to make better investments with fewer surprises.

As can be seen, there is a need for a system that provides a guide to a user's risk and reward tolerance.

### SUMMARY OF THE INVENTION

In one aspect of the present invention, a system for assessing investment risk comprises: a computer having a user interface; and a program product comprising a machine-readable program code for causing, when executed, the computer to perform the following process steps: prompting a user to enter investment information comprising at least an amount of money the user is going to invest, an amount of money the user expects to earn from the investment, and an amount of time the user expects to earn the money from the investment; prompting the user to input at least one risk answer to the at least one risk question to determine the amount of the investment the user is willing to risk; producing at least one reward question based on the user's entered investment information and the user's entered at least one risk answer; prompting the user to input at least one reward answer to at least one reward question to determine the minimum reward the user is willing to accept; and producing an analysis screen displaying a report comprising a beta based on the investment information, the at least one risk answer, and the at least one reward answer.

In another aspect of the present invention, a method for assessing investment risk comprises prompting a user to enter investment information comprising at least an amount of money the user is going to invest, an amount of money the user expects to earn from the investment, and an amount of time the user expects to earn the money from the investment; providing a plurality of risk and reward statements to the user based on the investment information; prompting a user to enter an input comprising agreeing or disagreeing with each risk and reward statements presented; and displaying an analysis of investment risk based on investment information and the input.

These and other features, aspects and advantages of the present invention will become better understood with reference to the following drawings, description and claims.

### BRIEF DESCRIPTION OF THE DRAWINGS

FIG. 1 provides a flow chart of an embodiment of the present invention;

FIG. 2 continues the flow chart of FIG. 1; and

FIG. 3 is a graphical chart of a report of a Beta displayed to an exemplary user.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a system and method of assessing a future investment. The present invention may include entering in personal information and investment information. The user may be presented with a series of risk and reward questions or statements in which the user may agree with or disagree with. The questions may progressively increase the risk and/or reward users are willing to take to achieve their goals. Once the questions have been answered, the software prepares and provides a risk and reward assessment.

In certain embodiments, the software may provide a series of specific questions for a user based on their detailed financial input. The user may input answers to the series of questions or statements and the software may calculate the beta based on the responses to the specific questions or statements and the index and interest rates used. The present invention may include an iterative process that continues until the user answers no to the questions or takes the maximum risk and minimum reward possible. The present invention may then provide a risk and reward assessment and risk and reward scale of the user based on the answers to the questions.

The present invention may help a user determine what stocks or mutual funds are an appropriate investment for their particular goals. The system does this by converting a user's subjective assessment of risk into a quantifiable risk range that allows the user to select investments which fall within their emotional capacity for risk. The system may provide visual and verbal displays of an objective assessment of their risk and reward tolerance.

The software of the present invention may calculate a beta for an individual or entity, using a standard or even a non-standard index or indices as a comparison. As mentioned above, the comparison is made by directing the individual or entity to answer questions or give responses to statements displayed by the program regarding their risk and reward perception or other variable pros and cons, such as minimum acceptable and maximum ranges. The beta is calculated by comparing those responses to minimum achievable or acceptable minimum and is compared with the actual average maximum or historical achieved results over time. The beta may then be presented to the user graphically and numerically within or beyond (1+Beta) the Pro/Con Risk/Reward range along with other key elements such as interest rates required for financial applications to achieve goals or production quantities needed for advanced additive manufacturing optimization. The software may thereby objectively show the beta for an individual or entity before investments are made in order to determine what beta fits the individual or entity's tolerance for risk in achieving the desired result and what is the minimum acceptable result.

In certain embodiments, the resultant beta may be outside a range of predetermined acceptable boundaries. With such results, the present invention may present information regarding alternate approaches or the present invention may display which desired results are not realistic or achievable within the constraints proposed by the individual or entity. For example in finance if the required Beta is greater than the index used as the benchmark that particular investment vehicle would not be appropriate. If the present invention is used to determine machinery needed for manufacturing, the resulting beta may be greater than the beta determined by the answers to the questions or measurements proposed. In such embodiments, the proposed or available machinery would not be sufficient for the task.

In certain embodiments, the present invention may include at least one computer with a user interface. The computer may include any computer including, but not limited to, a desktop, laptop, and smart device, such as, a tablet and smart phone. The computer includes a program product including a machine-readable program code for causing, when executed, the computer to perform steps. The program product may include software which may either be loaded onto the computer or accessed by the computer. The loaded software may include an application on a smart device. The software may be accessed by the computer using a web browser. The computer may access the software via the web browser using the internet, extranet, intranet, host server, internet cloud and the like.

In certain embodiments, a user may create a profile and sign onto the software. The user may then by provide personal investment information. The personal investment information may include range of income, amount willing to invest, the decision horizon defined as how long, such as in quarters, will it be before the current strategy is abandoned by the individual due to lack of performance, the investment length in years, the expected amount of return, annual additions, annual withdrawals, and the like. Once the user has entered their personal investment information, the computer may then present the user with specific risk and reward questions to the user.

In certain embodiments, the questions may change based on the user's input parameters. For example, the questions may change based on the amount willing to spend, decision horizon, terms and the like. The questions may further be based on which index is selected, which 80 quarters are being used, and by changing the index, for example, changing S&P 500 to Russell 2000 or Commodity Index. In certain embodiments, the questions progressively increase the risk and/or reward users are willing to take to achieve their goals. For example, the risk and/or reward may increase by 5% for each question. In certain embodiments, the minimum reward calculation basis for this example may be the most recent quarterly yield on the 90 day rate for US Treasuries.

Once the questions have been answered, the software prepares and provides a risk and reward assessment. As mentioned above, the risk and reward assessment may be called a beta. A unique beta is created for every user based on how much risk the user is willing to take. The risk and reward beta may be based on the answers to the questions. In certain embodiments, the beta may show the user's beta risk and reward scale and its relationship to standard indexes, such as the S&P 500. Once a user acquires the beta, the user may e-mail the beta to their own e-mail address or to their financial advisor so appropriate investment choices may be considered and made.

Any standard index which has a Beta of 1 may be appropriate for the system to use. For example the Beta of 1 may be assigned to the S&P 500 for 80 quarters by the creators of the index. This is the benchmark for the risk calculations. By comparing the resultant beta for the individual to the standard beta of 1, the individual may make an investment (spend) based on their resultant beta. For example if their resultant calculated beta is 1 the user may place all of their investment in a S&P index fund knowing that the investment is appropriate for their Risk tolerance. In such embodiments, the minimum reward is less than a Beta of 1. If their beta was 0.5 they could put half their investment in the index or other investment (mutual fund, stock portfolio) and half their investment in daily US Treasuries.

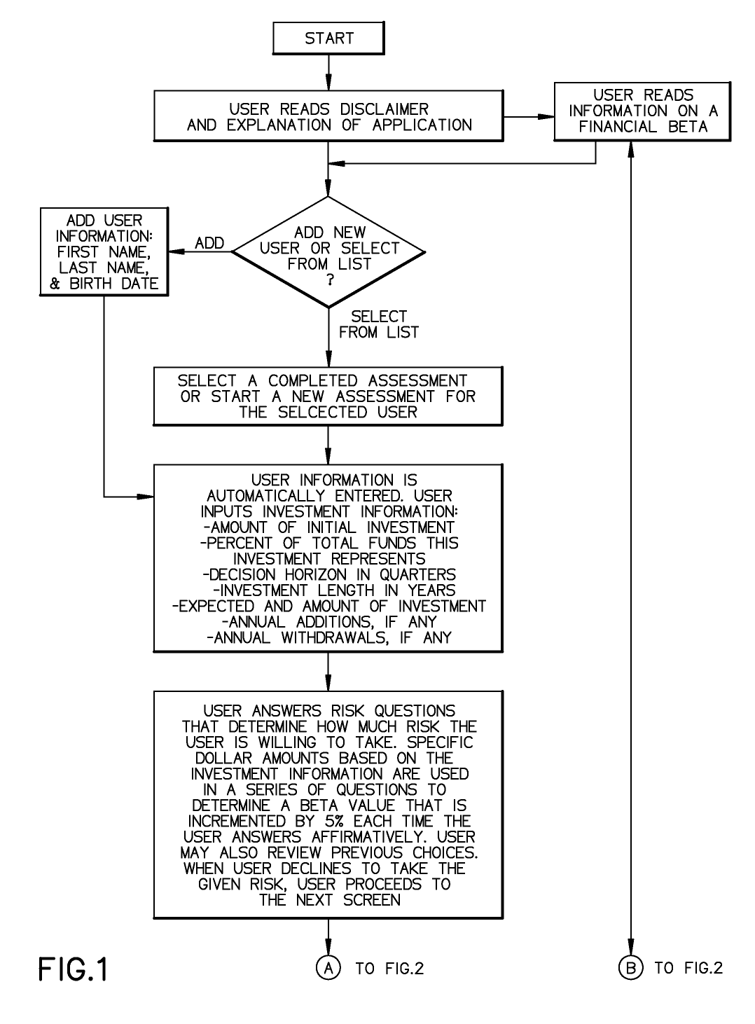

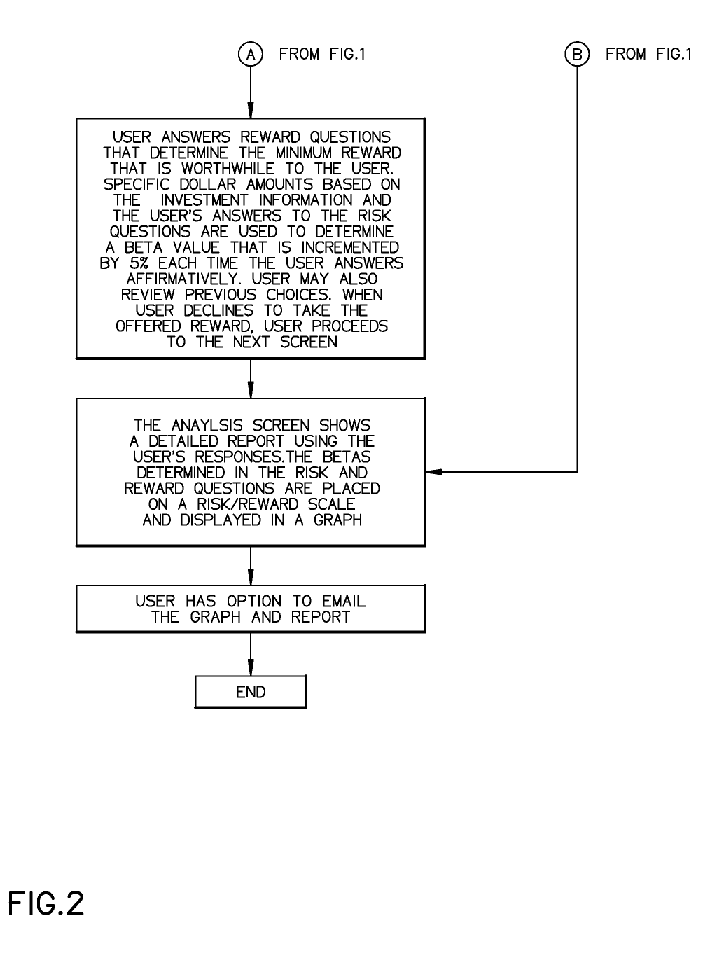

Referring to FIGS. 1 through 3, a user may first open the application on a computer such as a smart device. The user may read a disclaimer and an explanation of the application. In certain embodiments, the user may access a beta that has already been produced. In such embodiments, the computer may display an analysis screen showing the detailed report. Alternatively, the user may be presented with an option, such as add a new user or select a user from a list. If the user has already entered personal information previously, the user would select a user from a list. If the user is using the present invention for the first time, the user may add a user and input information, such as a first name, last name, and birth date.

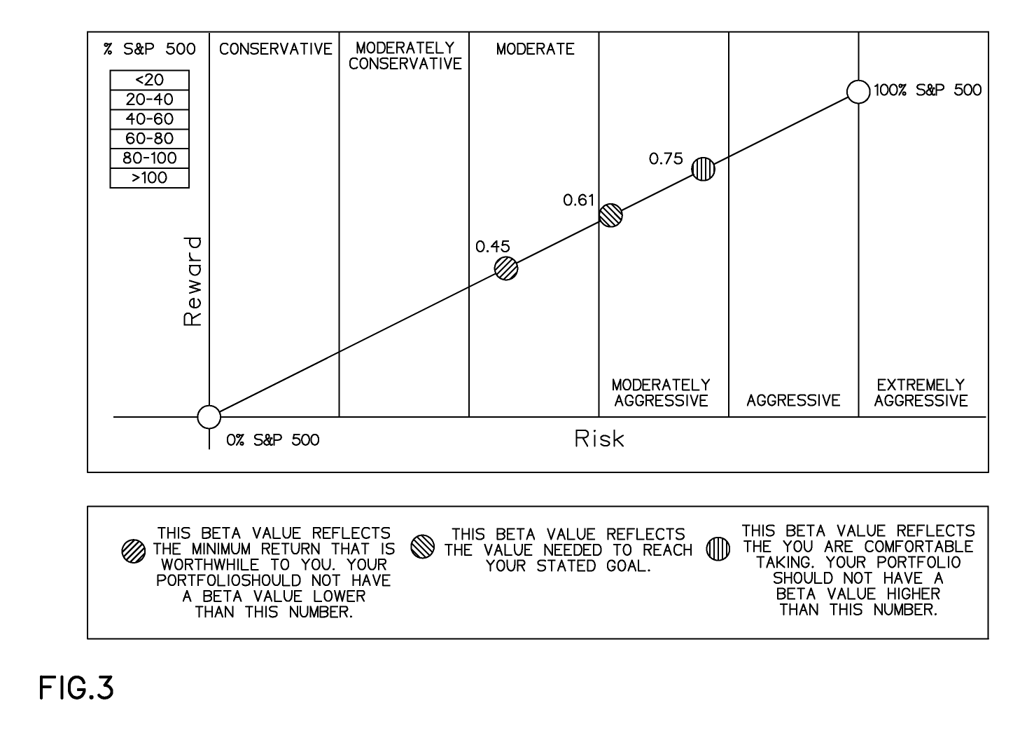

In certain embodiments, if the user selects themselves from the list, the user may be automatically prompted to either select a new assessment or a completed assessment. A new user may be directly prompted to create a new assessment. Once a user selects a new assessment, the personal user information may be entered and the user may input further information based on a potential investment. For example, the user may include the amount of initial investment, a percent of total funds the investment represents, a decision horizon in quarters, an investment length in years, an expected amount of return, annual additions and annual withdraws. The investment information gathered is used to calculate a user beta, which is displayed on the graph. Based on the user's amount invested and the user's expectation of return, the user's beta is calculated based on the past results of the S&P 500 as well as the interest rates for Treasury bonds. As illustrated in FIG. 3, the user's beta is 0.61. Therefore, for the user to gain the amount of money in the expected amount of time, the user would invest more in the S&P 500 based on the past quarters, such as the past 80 quarters.

Once the user has entered the investment information, the user may be presented with at least one risk question, such as a plurality of risk questions. The risk questions may be used to determine how much risk the user is willing to take. In certain embodiments, specific dollar amounts based on the investment information may be used in a series of yes or no questions to determine a beta value. Each question may be incremented by a 5% increase in the dollar amount each time the user answers affirmatively. The initial question may be a relatively low risk question. If the user answers affirmatively, the next question is a higher risk question. This is done until the user answers no. As an example, the first risk question may place the maximum risk beta at 0.5 and may increase with each question. The maximum risk beta, disclosed on the graph as is 0.75, is calculated once the user no longer wants to increase the risk. The user may also review previous choices. An example of a risk question may include the following: “For the next 90 days, would you take a 34% chance of losing anywhere from a dollar and potentially more than $7,857.00 (less than a 1% probability, often referred to as a Black Swan event) with an average possible loss of $2,472.00.”

When a user declines to take the given risk, the user may be presented with reward questions. The reward questions may be used to determine the minimum reward that is worthwhile to a user. In certain embodiments, specific dollar amounts based on the investment information and the user's answers to the risk questions may be used in a series of yes or no questions to determine a beta value. Each question may be incremented by a 5% increase in the dollar amount each time the user answers affirmatively. The minimum reward question may ask the user if a certain reward is too low. For example, when the scale is based on Treasury bonds and the S&P 500, the user may be first given a minimum reward question where 100% percent involves the purchase of Treasury bonds. Therefore, the reward minimum beta may start at 0 and increase with each affirmative answer to the reward questions. As illustrated in FIG. 3, the reward minimum beta is at 0.45. Therefore, a user may be comfortable investing more in Treasury bonds than the S&P 500. The user may review previous choices. The user may decline to take an offered reward and the user may proceed to the next screen.

In certain embodiments, the user may be presented with the probability of loss or gain using examples that apply to the user's knowledge base. For example, common gambling devices may be used, such as dice, roulette, cards, coins, or the like which may be illustrated to display the equivalent probability. For example, a 1% probably may be displayed as tossing six heads in a row when flipping a coin, whereas a 31% probably may be similar to picking a spade or ace from a standard deck of cards. Another example may include a 50% chance is equivalent to a coin flip. The examples may be created for any percentage between 1% and 99%.

The computer and software may compile the user's entered information to produce an analysis screen. The analysis screen may present a detailed report of the user's responses. The user's individual beta may be determined, and the risk and reward questions may be placed on a risk/reward scale and displayed in a graph as a range. FIG. 3 provides an exemplary graph displayed on a user's analysis page. The graph may provide a maximum risk beta and a minimum risk beta, which may provide a range in which the user's particular beta based on the entered investment information of the user should fall within. The maximum risk beta may be positioned on the graph based on the answers to the risk questions. A user that answers that they are willing to take more risk will raise the maximum risk beta closer to 100%. Therefore, the graph would suggest that the user invest more in the S&P 500, for example. In FIG. 3, this is shown as 0.75 beta. The minimum reward beta may be positioned on the graph based on the answers to the minimum reward questions answered. A user that answers that they are willing to take a lower minimum reward will lower the minimum reward beta closer to 0%. Therefore, the graph would suggest that the user invest more in Treasury bonds, for example. In FIG. 3, this is shown as 0.45 beta. In order for the program to state that the Beta requirement to achieve the individual's goal is appropriate, the user's beta may be at or below resultant individual maximum risk beta and at or above the individual's acceptable reward beta. As illustrated in FIG. 3, the user's beta is 0.61, which is in between 0.45 and 0.75. Therefore, the individual's investments, expectations, and comfort level match. The graph may also show what the individual's Beta translates to in standard investment profiles from Conservative to Extremely Aggressive. The following is an exemplary statement made in the analysis screen accompanying the graph of FIG. 3:
“The following information is based on the original parameters Daddy Warbucks entered on Oct. 17, 2013. It uses the S&P 500 data ending with the 2nd Quarter 2013. You stated that you were investing $100,000.00 initially and contributing a net of $10,000.00 annually for the purpose of Estate building and that you expect to have $400,000.00 after 15 years. You have stated that the average amount you are willing to risk losing over the next 90 days is $5,083.00 and that you understand there is a remote chance (1% probability) you could lose $16,905.00 or more in that same time period. You also stated that the minimum acceptable return was $6,979.00 over your 8 quarter decision horizon.
After analyzing your chart, you now know something very important about yourself, something that will help you make better investment decisions and help your advisor make better recommendations. You have moved from the subjective to the quantifiable. Rather than defining your risk level with adjectives such as, “moderate,” or “aggressive,” you have defined, in relative terms, your emotional capacity for the level of risk you believe you will be comfortable with by targeting a Beta level. Most investments have a Beta or a proxy Beta, their volatility compared to a broad market index. This allows you to do several important analyses:
   You can compare the weighted beta (each asset's Beta times (x) the percentage of your total assets it represents added together), your portfolio's risk characteristic, to your emotional capacity for risk. If your portfolio's Beta is higher than 0.75 you may well be over risking and should consider reducing your risk level. If your portfolio's Beta is below 0.45 you may be under rewarding yourself in the long haul.
   You can compare the Beta of your required risk level (the level of risk that offers the possibility for the return level you need to make your financial goals) against your emotional capacity for risk. This will high light how realistic your return goals are compared to what risk you are willing to accept. To reach your goal, you need an average annual return of 4.89%. Your portfolio's required risk is 0.61, which falls between your minimum return requirement and your maximum risk level. This goal is appropriate for your current emotional capacity of risk.
   You can assess the impact of adding, deleting, or changing the amount of an asset in your portfolio will have on your portfolio's risk characteristic compared to your target risk level. Your target Beta seems well suited to a portfolio of mutual funds or stock portfolios that match this Beta.
   You can reassess your risk level routinely or when major events occur, i.e. job changes, raises, changes in family matters, and make appropriate portfolio adjustments.
   You can forward your self assessment to your advisor(s) so they can make appropriate suggestions and proposals.”
      The user may save, or e-mail the results to themselves or potential financial planners. The user may use the beta to determine a proper investment In certain embodiments, the methodology of the present invention may be applied to non Financial simulations as long as a standard minimum output (minimum reward) and a Beta for performance is available (history for an activity).

The computer-based data processing system and method described above is for purposes of example only, and may be implemented in any type of computer system or programming or processing environment, or in a computer program, alone or in conjunction with hardware. The present invention may also be implemented in software stored on a computer-readable medium and executed as a computer program on a general purpose or special purpose computer. For clarity, only those aspects of the system germane to the invention are described, and product details well known in the art are omitted. For the same reason, the computer hardware is not described in further detail. It should thus be understood that the invention is not limited to any specific computer language, program, or computer. It is further contemplated that the present invention may be run on a stand-alone computer system, or may be run from a server computer system that can be accessed by a plurality of client computer systems interconnected over an intranet network, or that is accessible to clients over the Internet. In addition, many embodiments of the present invention have application to a wide range of industries. To the extent the present application discloses a system, the method implemented by that system, as well as software stored on a computer-readable medium and executed as a computer program to perform the method on a general purpose or special purpose computer, are within the scope of the present invention. Further, to the extent the present application discloses a method, a system of apparatuses configured to implement the method are within the scope of the present invention.

It should be understood, of course, that the foregoing relates to exemplary embodiments of the invention and that modifications may be made without departing from the spirit and scope of the invention as set forth in the following claims.

What is claimed is:

1. A system for assessing investment risk comprising:
a computer having a user interface; and
a program product comprising a machine-readable program code for causing, when executed, the computer to perform the following process steps:
prompting a user to input investment information comprising at least an amount of money the user is going to invest, an amount of money the user expects to earn from the investment, and an amount of time the user expects to earn the money from the investment;
producing at least one risk question based on the user's entered investment information;
prompting the user to input at least one risk answer to the at least one risk question to determine the amount of the investment the user is willing to risk;
producing at least one reward question based on the user's entered investment information;
prompting the user to input at least one reward answer to at least one reward question to determine the minimum reward the user is willing to accept; and
producing an analysis screen displaying a report comprising a beta based on the investment information, the at least one risk answer, and the at least one reward answer.

2. The system of claim 1, further comprising the step of producing an analysis screen displaying a graph comprising a beta range comprising a minimum reward beta based on the minimum reward questions, a maximum risk beta based on the maximum reward questions, and a user beta based on the investment information.

3. The system of claim 2, wherein the graph is scaled based on a low risk investment and a high risk investment, wherein the low risk investment is Treasury Bonds and the high risk is S&P 500, wherein the betas are compared to past quarters of the S&P 500 and the current interest of the Treasury Bonds.

4. The system of claim 1, further comprising the step of prompting a user to select from a completed assessment or a new assessment, wherein the selecting the new assessment prompts a user to input investment information comprising at least an amount the user is going to invest.

5. The system of claim 1, wherein the investment information further comprises at least one of the following: a percentage of the investment based on a total the user's net worth, a decision horizon in quarters, an expected amount of annual additions, and an expected amount of annual withdrawals.

6. The system of claim 1, wherein the at least one risk question comprises a plurality of sequential questions comprising a yes or no answer.

7. The system of claim 6, wherein each sequential question provides a dollar amount based on the investment information and the answers to the previous questions.

8. The system of claim 7, further comprising the step of receiving a yes input and displaying a new yes and no question, wherein the dollar amount is increased by 5%.

9. The system of claim 6, further comprising the step of receiving a no input initiating the production of at least one reward question.

10. The system of claim 1, wherein the at least one reward question comprises a plurality of sequential questions comprising a yes or no answer.

11. The system of claim 10, wherein each sequential question provides a dollar amount based on the investment information and the answers to the previous reward questions.

12. The system of claim 10, further comprising the step of receiving a yes input and displaying a new yes and no question, wherein the dollar amount is increased by 5%.

13. The system of claim 10, further comprising the step of receiving a no input initiating the production of the analysis screen.

14. The system of claim 1, further comprising the step of graphing a plurality of betas and displaying the graph.

15. The system of claim 1, wherein the at least one reward question and the at least one risk question provides a percentage of risk and reward and a representation of the percentage produced as common gambling devices.

16. A method for assessing investment risk comprising:
prompting a user to enter investment information comprising at least an amount of money the user is going to invest, an amount of money the user expects to earn from the investment, and an amount of time the user expects to earn the money from the investment;
providing a plurality of risk and reward statements to the user based on the investment information;
prompting a user to enter an input comprising agreeing or disagreeing with each risk and reward statements presented; and
displaying an analysis of investment risk based on investment information and the input.

17. The method of claim 16, wherein the investment information further comprises at least one of the following: a percentage of the investment based on a total the user's net worth, a decision horizon in quarters, an expected amount of annual additions, and an expected amount of annual withdrawals.

18. The method of claim 16, wherein each sequential risk and reward statement provides a dollar amount based on the investment information and the inputs to the previous statements.

19. The system of claim 16, further comprising the step of receiving an agreeing input and displaying a new risk and reward statement, wherein the dollar amount is increased by 5%, and receiving a no input initiating the displaying of the analysis.

20. The system of claim 16, further comprising the step of producing an analysis screen displaying a graph comprising a beta range comprising a minimum reward beta based on the risk statements, a maximum risk beta based on the maximum reward statements, and a user beta based on the investment information.
